(19) United States
(12) Patent Application Publication
(10) Pub. No.: US 2002/0054278 A1
(43) Pub. Date: May 9, 2002

(54) Timing data recording device

(76) Inventors: Daiki Tsukahara, Tokyo (JP); Hiroshi Wakabayashi, Yokohama-shi (JP)

Correspondence Address: STAAS & HALSEY LLP, 700 11TH STREET, NW, SUITE 500, WASHINGTON, DC, 20001, US

(21) Appl. No.: 09/504,906

(22) Filed: Feb. 16, 2000

Related U.S. Application Data
(63) Continuation of application No. 08/873,089, filed on Jun. 11, 1997, now abandoned.
Application No. 08/873,089 is a continuation of application No. 08/671,500, filed on Jun. 27, 1996, now abandoned.

(30) Foreign Application Priority Data
Jun. 29, 1995 (JP) 7-163929

(51) Int. Cl. G03B 27/72

(52) U.S. Cl. 355/35

(57) ABSTRACT

A timing data recording device that prevents imprinting of incorrect timing data on a recording medium, such as a film loaded in a camera. The timing data recording device operates by power supply voltage from a detachable battery. When the battery of the timing data recording device is changed, a flag is automatically set so that imprinting of timing data on the film is inhibited. While this flag is set, there is no recording of incorrect timing data on the film. Moreover, when the battery is changed, until a data correction mode has been performed in order to correct the date and time, the flag remains set such that imprinting is inhibited. Thus, a user of the camera does not forget to reset the date and time after a battery change. Furthermore, the data correction mode is set only in the case that the usual select switch is actuated continuously for a predetermined time. In contrast to this, when the select switch is actuated after a battery change, the data correction mode is immediately set, so that timing data correction is facilitated and the device is easy to use.

### BACKGROUND OF THE INVENTION

1. Field of the Invention

The present invention relates to a timing data recording device using a timing device. More particularly, the invention relates to a timing data recording device, which inhibits recordation of incorrect timing data on a recording medium, such as film, when a battery, which is used for a power supply for the timing data recording device, is changed until the timing data is reset.

2. Description of the Related Art

Cameras are known which optically or magnetically record date, time, etc. on a film. This kind of camera is equipped with a timing device consisting of an IC or the like within the camera, and records the timing data on the film, based on the output from this timing device. The timing device receives current from the usual power supply, and operates whether the main power supply of the camera is ON or OFF. However, because batteries have a finite lifetime, it is necessary to change them after a certain time has elapsed. During a battery change, because for a moment the power supply voltage is not supplied to the timing device, the operation of the timing device momentarily stops, and after the battery change, the timing device outputs incorrect timing data.

Consequently, when the battery used as the power supply of the timing device is changed, the timing data of the timing device is generally reset to initial data. Moreover, cameras are known in which, because there is a risk that by only resetting, incorrect timing data will be recorded on the film. The initial data is thus used as a standard. There is an automatic changeover after a battery change to a mode in which timing data is not recorded on the film (termed “OFF mode” hereinbelow).

Nevertheless, even if there is temporarily an automatic changeover to the OFF mode, in a case that after this the user resets the data recording mode without performing a correction of the timing data, incorrect timing data will be recorded on the film.

### SUMMARY OF THE INVENTION

Accordingly, it is an object of the present invention to provide a timing data recording device which prevents the recording of incorrect timing data on a recording medium, even when a power source such as a battery is changed.

Objects of the present invention are achieved by providing a timing data recording device, comprising: a timing device that outputs timing data which changes according to time; a changing device which changes the timing data into indicated other data; a reset device that changes the timing data to predetermined initial data; a recording device which records on a recording medium at least a portion of the timing data which was output from the timing device; and a recording control device that inhibits the recording of the timing data to the recording medium during an interval from changing the timing data to the initial data by using the reset device until the timing data is changed by using the changing device.

The present invention may include a timing device that outputs timing data; a recording device that records at least a part of the timing data on a recording medium; an inhibiting device that inhibits the recording of the timing data onto the recording medium; and an ensuring device that ensures the timing data is not improperly printed on the recording medium.

From the time point at which the reset device changes the timing data to initial data, the period until the changing device changes the timing data of the timing device is such that timing data cannot be recorded on the recording medium. Thus, incorrect timing data is not recorded on the recording medium. When the timing data has been reset, because recording of the timing data on the recording medium is inhibited unless the timing data has been corrected by means of the change means, there is no risk of recording incorrect timing data.

In the timing data recording device, when the recording control device inhibits the recording of the timing data, a predetermined operating member is actuated. When the recording control device does not inhibit the recording of the timing data, the operating member was continuously actuated for more than a predetermined time. A change permission device permits the changing of the time data by using the changing device. Because the timing data can immediately be changed, if the operating member is operated during the timing data recording inhibition period, regardless of the operating time, changing the timing data will not be forgotten after starting the reset device.

When a predetermined operating member operates while the recording of timing data is inhibited, regardless of its operating time, the timing data can change. On the other hand, in a case in which recording of the timing data is not inhibited, the timing data changes only in the case where the operating member is actuated continuously for more than a predetermined time. As it is possible to change, by means of operation of the predetermined operating member, the kind of timing data which the display device is displaying, it is possible for only the necessary data to be displayed by the display device. Moreover, because a changeover of the display mode is performed by the operating member in order to start the change device, the number of operating members can be reduced, and the cost can be decreased.

The timing data recording device, as embodied herein, is able to output a plurality of timing data, which includes at least the time data and a date data. Preferably, the timing data recording device includes a display device that can display at least some of the plurality of timing data which have been output. When the operating member operates only a shorter time than the predetermined time, and when the recording control device does not inhibit the recording of the timing data, a display control device converts the types of timing data to be displayed by the display device. When the predetermined operating member is actuated only for a time shorter than a second time when the recording of timing data is not inhibited, the kind of timing data displayed by the display device changes.

The timing device preferably operates by means of a power supply voltage which is supplied from a detachable power supply device. The reset device, at least during the detachment of the power supply device, sets the timing data timed by using the timing device to the predetermined initial data. While the power supply device, which supplies a power supply voltage to the timing device, is detached, initial data is automatically set in the timing device. Since the timing data timed by the timing device is changed to the initial data when the power source device which supplies power supply voltage to the timing device is changed, there is no risk of misleading and incorrect timing data being displayed. Moreover, the user can be urged to perform resetting.

Furthermore, the recording medium preferably is a film, and the recording device converts the timing data to magnetic data and records it on the film. While timing data is converted to magnetic data and recorded on the film, incorrect timing data is not recorded on the film. When magnetically recording on the film, there is no risk of recording incorrect timing data on the film.

Additional objects and advantages of the invention will be set forth in part in the description which follows and, in part, will be obvious from the description, or may be learned by practice of the invention.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a block diagram of an embodiment of a timing data recording device according to the present invention;

FIG. 2 is a detailed view of a display unit for the timing data recording device;

FIG. 3 is a flow chart showing a summary of the photographic process which a CPU performs for the timing data recording device;

FIG. 4 is a detailed flow chart of the data recording process of step S7 of FIG. 3;

FIG. 5 is a flow chart showing the Select switch actuation process which the CPU performs;

FIG. 6 is a detailed flow chart of the data correction mode process of step S23 of FIG. 5;

FIG. 7 is a detailed flow chart of the display mode change process of step S25 of FIG. 5;

FIGS. 8(a) and 8(b) are diagrams showing cases of lighting a portion of date data;

FIG. 9(a) is a diagram depicting a display example of the date display mode;

FIG. 9(b) is a diagram illustrating a display example of the time display mode;

FIG. 9(c) is a diagram showing a display example of the OFF mode;

FIG. 10 is a flow chart showing the date sequence change process which the CPU performs;

FIGS. 11(a), 11(b), and 11(c) are diagrams showing the changing of the sequence of date data according to the actuation of the adjust switch;

FIG. 12 is a diagram collecting the process contents of the data correction mode process and display mode change process;

FIG. 13 is a diagram showing the initial data of a timing data which is displayed at a battery change; and

FIG. 14 is a block diagram of a timing data recording device which records timing data on film by an optical device.

### DESCRIPTION OF THE PREFERRED EMBODIMENTS

Reference will now made in detail to the present preferred embodiments of the present invention, examples of which are illustrated in the accompanying drawings, wherein like reference numerals refer to the like elements throughout. The embodiments are described below in order to explain the present invention by referring to the figures.

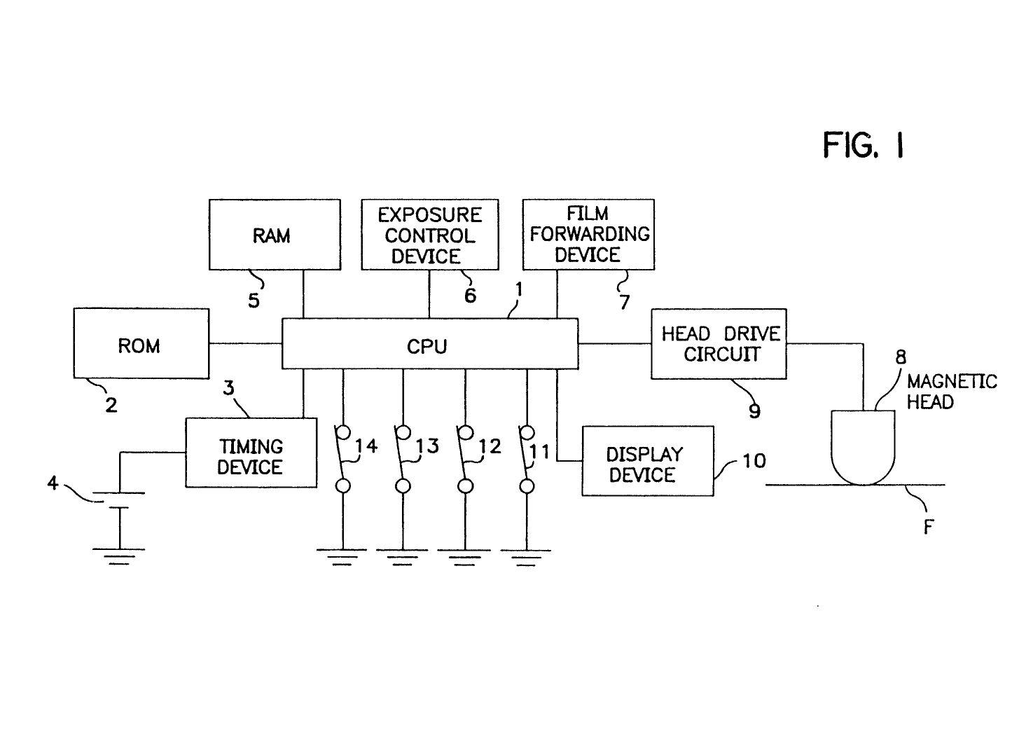

FIG. 1 is a block diagram of the first embodiment of a timing data recording device according to the present invention. In the first embodiment, the timing data recording device is described with regard to its incorporation in a camera.

In FIG. 1, CPU 1 controls the entire device and performs the processes according to FIGS. 3-7 using a program stored in ROM 2. Timing device 3 outputs timing data relating to date and time. Timing device 3 receives a power supply voltage from battery 4. Moreover, in this embodiment, battery 4 is for exclusive use by timing device 3. The other components of the camera are supplied with power supply voltage from another battery (not shown in the drawing).

RAM 5 stores results calculated by the CPU 1 along with a flag showing whether or not battery 4 is being changed. The flag is automatically set when battery 4 is changed. Recording of timing data to film F is inhibited while the flag is set. Exposure control device 6 controls an aperture or a shutter (not shown in the drawing). Film forwarding device 7 performs winding-on and rewinding of film F. Magnetic head 8 magnetically records timing data. Head drive circuit 9 controls magnetic head 8.

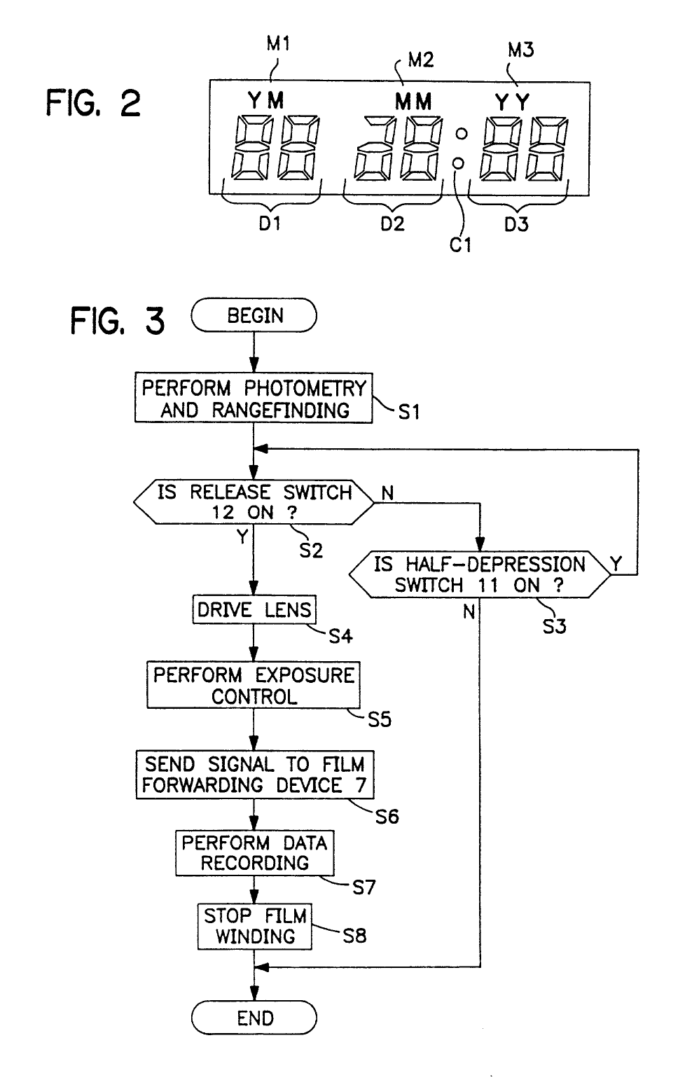

Display device 10 is, for example, a liquid crystal display device, which displays the timing data. Display device 10, as shown in FIG. 2, includes three data display units D1, D2, D3. In each of data display units D1-D3, respectively, two columns of numerical values can be displayed. Moreover, symbols which represent “year” or “month” above each data display unit D1-D3 can display year and month display units Ml, M2, M3, and color mark C1 can be displayed between data display unit D2 and data display unit D3.

Half depression switch 11 is set ON by half depression of a release button (not shown in the drawing). Release switch 12 is set ON by full depression of the release button. Select switch 13 indicates mode changeover, a mode to correct the data or the time, etc. Adjust switch 14 sets the specific numerical value of the date or time.

FIG. 3 is a flow chart showing a summary of the photographic process which the CPU 1 performs when the half depression switch 11 is ON. The operation of the first embodiment is described below, based on this flow chart. In step S1, photometry and rangefinding are performed, using a photometric device and a focus data detection device (not shown in the drawing). In step S2, it is determined whether release switch 12 is ON. In the case that it is not ON, proceeding to step S3, it is determined whether half depression switch 11 is ON. In the case where half depression switch 11 is not ON, the process ends. In the case that switch 11 is ON, the process returns to step S2.

When it is determined in step S2 that the release switch 12 is ON, the process continues to step S4 where a camera lens (not shown in the drawing) is driven, based on the process results of step S1. Next, in step S5, exposure control is performed to control opening and closing of the shutter based on the process results of step S1.

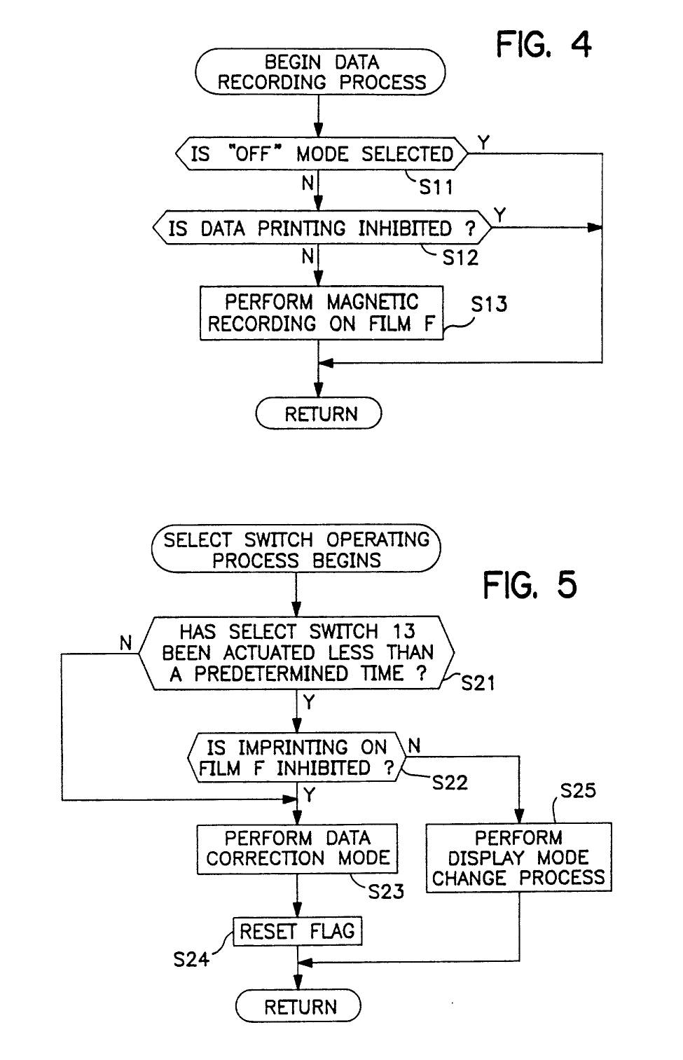

In step S6, a signal is sent to film forwarding device 7, and winding on of film F commences. In step S7, a data recording process, shown in detail in FIG. 4, is performed, and timing data and the like is recorded on film F during the performance of winding-on of film F. After the data recording process of step S7, the film-winding stops in step S8.

FIG. 4 is a detailed flow chart of the data recording process of step S7 of FIG. 3. In step S11 of FIG. 4, it is determined whether the mode of not recording timing data on the film F (the OFF mode) is selected. Moreover, selection of the OFF mode is performed by means of select switch 13. In the case that the OFF mode is selected, the process finishes and returns. In the case that the OFF mode is not selected, namely in the case where recording on film F (termed “data imprinting” hereinbelow) is desired, the process proceeds to step S12.

In step S12, it is determined whether data imprinting is inhibited. Specifically, flag data stored in RAM 5 is read out. When the flag is set, it is determined that data imprinting is inhibited, and the process ends and returns without performing data imprinting. On the other hand, in the case that the flag is not set, the process continues with step S13 where data and the like are sent to the head drive circuit 9, and magnetic recording on the film F is performed by magnetic head 8.

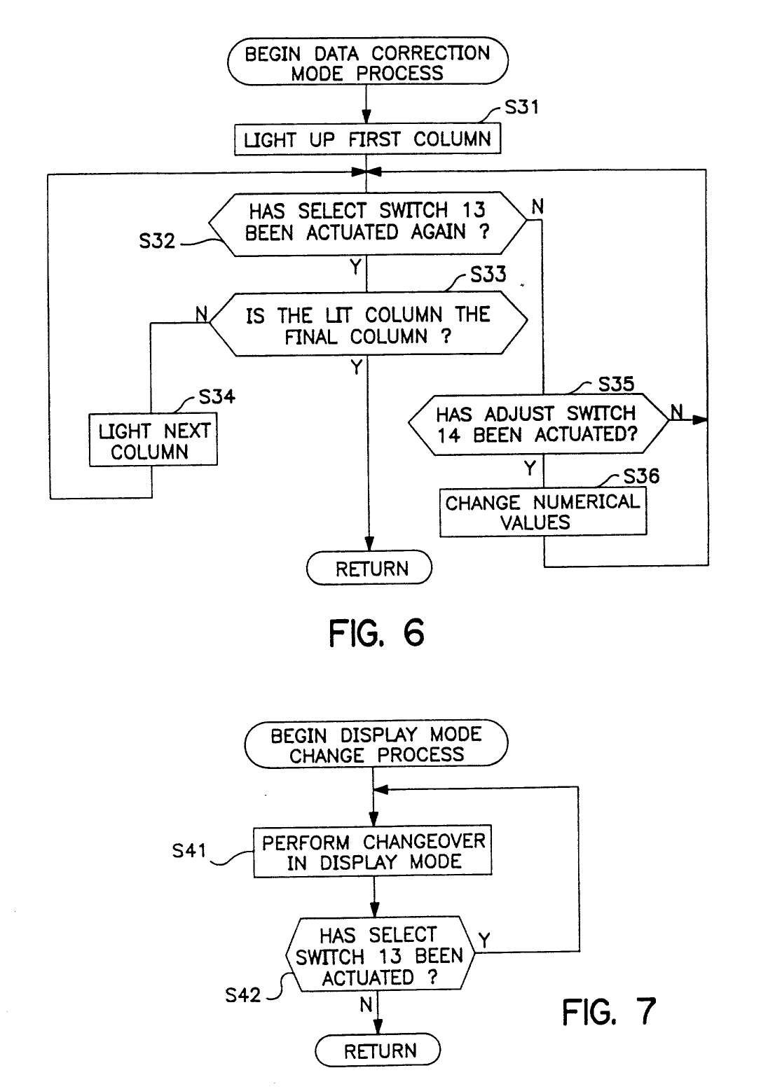

FIG. 5 is a flow chart showing the select switch operating process which CPU 1 performs when select switch 13 is actuated. In step S21 of FIG. 5, it is determined whether the time for which select switch 13 has been continuously actuated is less than a predetermined time (for example, two seconds). In the case that it is less than the predetermined time, the process continues with step S22 where the flag data stored in the RAM 5 is read out, and it is determined whether the flag is set, that is, whether imprinting on film F is inhibited. In the case that data imprinting on film F is inhibited, the process continues with step S23, where the data correction mode process, shown in detail in FIG. 6, is performed. Next, in step S24, the flag is reset, and the process returns. Accordingly, data imprinting to film F becomes possible thereafter. In the case that imprinting on film F is not inhibited in step S22, the process continues with step S25 where the display mode change process is performed, as shown in detail in FIG. 7.

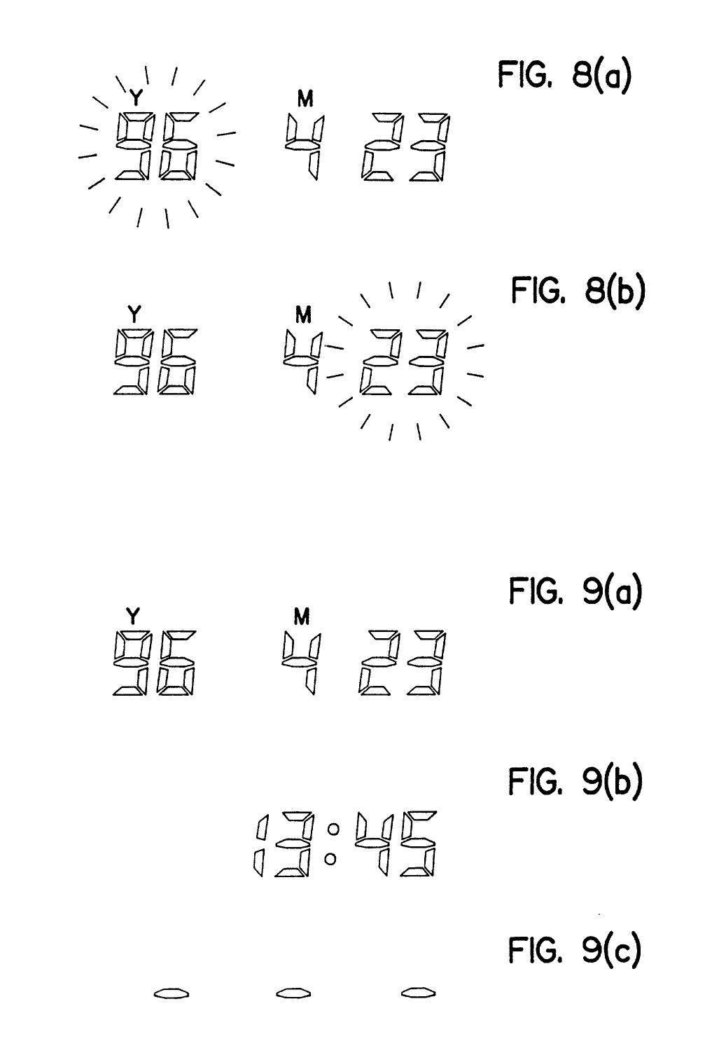

Next, the details of the data correction mode process of step S23 of FIG. 5 will be described with reference to the flow chart of FIG. 6. In step S31, the first column is caused to light up, as shown in FIG. 8(a). Moreover, FIGS. 8(a) and 8(b) show a date display example. In step S32, it is determined whether select switch 13 has been actuated again. When actuated, the process continues with step S33 where it is determined whether the column which has been lighted up to now is the final column. If affirmative, the process returns. For example, as shown in FIG. 8(b), when the last column of the data display is lit directly before select switch 13 operates, the determination in step S33 is affirmative, and the process returns.

In this manner, when select switch 13 is actuated in the state in which the last column is lit, because the process has passed through from the data correction mode process and because another step is unnecessary in order to escape from the data mode correction process, the cost is reduced. On the other hand, in the case where the determination in step S33 is negative, that is, a column other than the last column was lit, the process continues by lighting the next column in step S34. The process then returns to step S32.

In the case where the determination of step S32 is negative, that is, select switch 13 is not actuated again, the process continues to step S35 where it is determined whether adjust switch 14 has been actuated. In the case where adjust switch 14 has not been actuated, the process returns to step S32. In the case where adjust switch 14 has been actuated, the numerical values are changed where actually lighted in step S36. Specifically, each time adjust switch 14 is actuated, the numerical value is incremented by one unit.

Next, the display mode change process of step S25 of FIG. 5 is described in detail using the flow chart of FIG. 7. The changeover of the display mode is performed in step S41. Specifically, the changeover is in the following sequence of display modes: date display mode→time display mode →OFF mode →date display mode→. . . In the image display examples, FIG. 9(a) shows the date mode, FIG. 9(b) shows the time mode, and FIG. 9(c) shows the OFF mode. When the process of step S41 ends, it is determined in step S42 whether select switch 13 has again been actuated. In the case that it was actuated, the process returns to step S41, and if not actuated, the process returns.

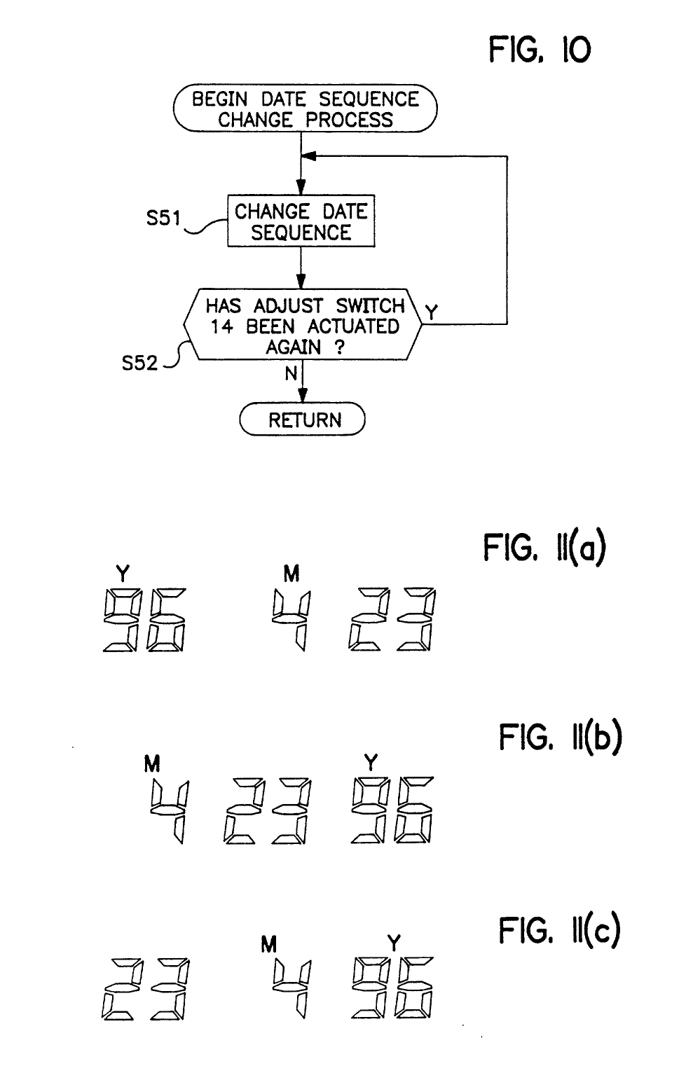

FIG. 10 is a flow chart showing the date sequence change process which CPU 1 performs when adjust switch 14 is continuously actuated for more than a predetermined time (for example, two seconds). In step S51 of FIG. 10, as shown by FIGS. 11(a), 11(b), and 11(c), the date sequence changes over in the sequence “year, month, day”→“month, day, year”→“day, month, year”. . . In step S52, it is determined whether adjust switch 14 has been actuated again. If adjust switch 14 has been actuated, the process returns to step S51, and in the case that adjust switch 14 has not been actuated, the process returns.

FIG. 12 is a diagram in which the process contents of the data correction mode process and the display mode change process, described above, are arranged in order. Frame A of FIG. 12 shows the process of the data correction mode. According to the actuation of select switch 13, the lighted positions change in the sequence “year”→“month”→“day”→“hours”→“minutes”, and it is possible to change the lighted numerical value by means of adjust switch 14.

As described in FIG. 6, the process in order to enter the data correction mode is (1) select switch 13 is actuated (not related to the actuation time) in the case when there is an imprinting inhibition state, (2) select switch 13 is actuated continuously a predetermined time, in the case where there is no inhibition of imprinting. Moreover, the process of escaping from the data correction mode occurs when select switch 13 is actuated when the “minutes” data is the lighted display.

Frame B of FIG. 12 shows the changes of the display mode. In this embodiment, the three display modes are the date display mode which displays the date, the time display mode which displays the time, and the OFF mode which displays neither date nor time. By actuation of select switch 13, one of the display modes is selected.

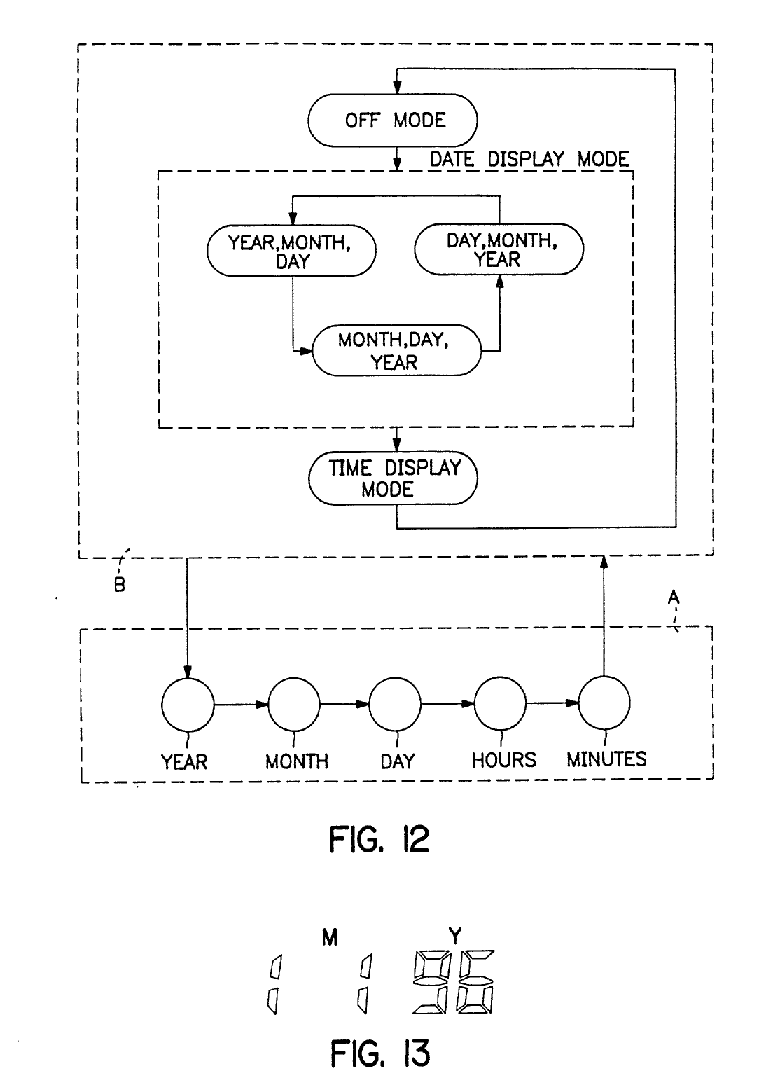

In this manner, in this embodiment, when battery 4 of timing device 3 is changed, the timing data is reset as shown in FIG. 13, and in addition the flag is set. While the flag is set, because data imprinting on the film F is inhibited, incorrect timing data is not imprinted on film F. Moreover, when battery 4 is changed, because the flag is set except when the data correction mode is entered in order to correct the date and time, resetting the date and time after a battery change will not be forgotten. Furthermore, normally the data correction mode is set only when selector switch 13 is actuated continuously for a predetermined time. In contrast to this, because the data correction mode is set immediately upon actuation of select switch 13 after a battery change, the operation of correcting the timing data is facilitated.

In step S24 of FIG. 5, after having performed the data correction mode process, the flag is reset. In addition to resetting the flag, there may also be an automatic changeover to the data imprinting mode.

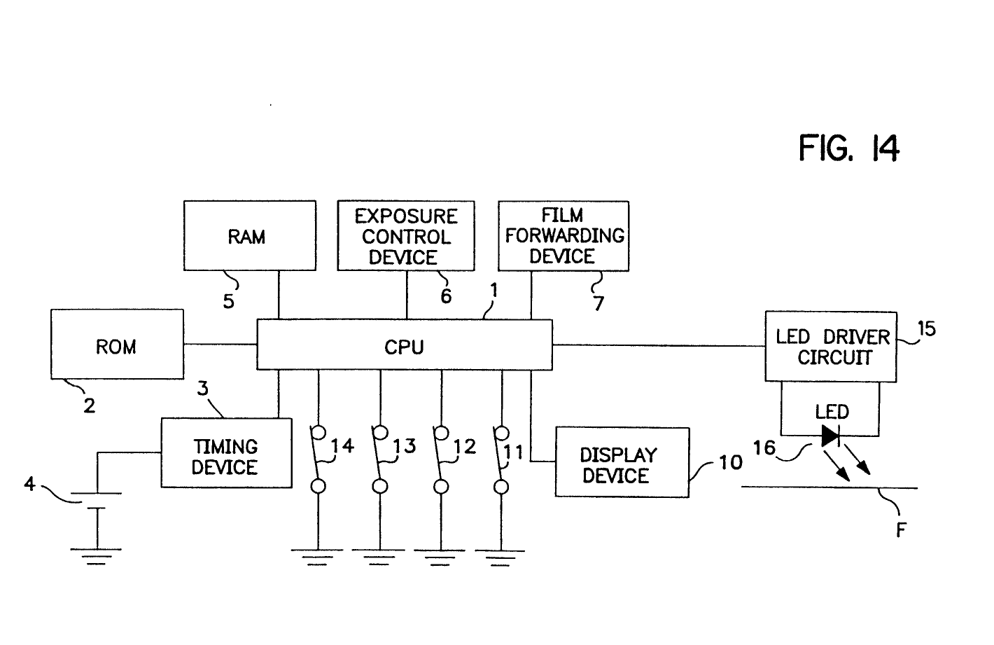

In the first embodiment, the timing data is recorded by a magnetic device and method on film F, but as shown in FIG. 14, the recording may be by an optical device and method. In FIG. 14, instead of head drive circuit 9 and magnetic head 8 of FIG. 1, an LED drive circuit 15 and LED 16 are connected. Thus, it is clear that other ways of recording the data on the film are equally possible, besides magnetic recording.

In the first embodiment, a display example is shown in which date and time are separately interchanged, but these may be simultaneously displayed and recorded. Moreover, the specific content of the timing data is not limited to that described in connection with the first embodiment. For example, displaying the [Japanese] year symbol (ex., Heisei), or displaying down to units of seconds, are also possible. Furthermore, as the initial value, a date display other than the one of Jan. 1, 1996 shown in the first embodiment or character data such as “AAA”, “EEE”, “___”, etc., may be displayed.

In the above embodiment example, the timing data recording device has been described as incorporated into a camera, but the present invention can be applied to various electrical equipment other than cameras.

In the embodiments described above, the following respectively correspond: the data setting mode process of FIG. 6 to the changing device; timing device 3 to the reset device; film F to the recording medium; magnetic head 8 and head drive circuit 9 (or LED drive circuit 15 and LED 16) to the recording device; the data recording process of FIG. 4 to the recording control device; select switch 13 to the predetermined operating member; step S22 of FIG. 5 to the change permission device; the display device 10 to the display device; the display mode setting process of FIG. 7 to the display control device; and the battery 4 to the power supply device.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A timing data recording device, comprising:
a timing device that outputs timing data which changes according to time;
a changing device which changes the timing data into indicated other data;
a reset device that changes the timing data to predetermined initial data;
a recording device which records on a recording medium at least a portion of the timing data which was output from the timing device; and
a recording control device that inhibits the recording of the timing data to the recording medium during an interval from changing the timing data to the initial data by using the reset device until the timing data is changed by using the changing device.

2. A timing data recording device according to claim 1, further comprising a predetermined operating member, which is actuated when the recording control device inhibits the recording of the timing data, and which continues to be actuated for more than a predetermined time when the recording control device does not inhibit the recording of the timing data; and
a change permission device that permits the changing of the time data by using the changing device.

3. A timing data recording device according to claim 1, wherein the timing device outputs a plurality of the timing data, said timing data including at least time data and date data.

4. A timing data recording device according to claim 2, wherein the timing device outputs a plurality of the timing data, said timing data including at least time data and date data.

5. A timing data recording device according to claim 3, further comprising a display device, which can display some of the plurality of timing data which has been output; and
a display control device, wherein when the operating member is actuated for only a time shorter than the predetermined time, and when the recording control device does not inhibit the recording of the timing data, the display control device converts the plurality of timing data displayed by the display device.

6. A timing data recording device according to claim 4, further comprising a display device, which can display some of the plurality of timing data which has been output; and
a display control device, wherein when the operating member is actuated for only a time shorter than the predetermined time and when the recording control device does not inhibit the recording of the timing data, the display control device converts the plurality of timing data displayed by the display device.

7. A timing data recording device according to claim 1, further comprising a detachable power supply device that powers the timing device with a power supply voltage; and
wherein the reset device, at least during detachment of the power supply device, sets the timing data timed by using the timing device to the predetermined initial data.

8. A timing data recording device according to claim 2, further comprising a detachable power supply device that powers the timing device with a power supply voltage; and
wherein the reset device, at least during detachment of the power supply device, sets the timing data timed by using the timing device to the predetermined initial data.

9. A timing data recording device according to claim 3, further comprising a detachable power supply device that powers the timing device with a power supply voltage; and
wherein the reset device, at least during detachment of the power supply device, sets the timing data timed by using the timing device to the predetermined initial data.

10. A timing data recording device according to claim 4, further comprising a detachable power supply device that powers the timing device with a power supply voltage; and
wherein the reset device, at least during detachment of the power supply device, sets the timing data timed by using the timing device to the predetermined initial data.

11. A timing data recording device according to claim 5, further comprising a detachable power supply device that powers the timing device with a power supply voltage; and
wherein the reset device, at least during detachment of the power supply device, sets the timing data timed by using the timing device to the predetermined initial data.

12. A timing data recording device according to claim 6, further comprising a detachable power supply device that powers the timing device with a power supply voltage; and
wherein the reset device, at least during detachment of the power supply device, sets the timing data timed by using the timing device to the predetermined initial data.

13. A timing data recording device according to claim 1, wherein the recording medium is a film; and
wherein the recording device, after converting the timing data to magnetic data, records it on the film.

14. A timing data recording device comprising:
a timing device that outputs timing data;
a recording device that records at least a part of the timing data on a recording medium;
an inhibiting device that inhibits the recording of the timing data onto the recording medium; and
an ensuring device that ensures the timing data is not improperly printed on the recording medium.

15. A timing data recording device as claimed in claim 14, further comprising a CPU, and wherein the inhibiting device and the ensuring device includes a data recording process run by the CPU.

16. A timing data recording device as claimed in claim 14, further comprising a changing device that changes the timing data into a different format.

17. A timing data recording device as claimed in claim 14, wherein said recording device is a magnetic head and a magnetic head drive circuit.

18. A timing data recording device as claimed in claim 14, wherein said recording device is an LED and an LED drive circuit.

19. A method of printing correct timing data on a recording medium, said method comprising the steps of:
generating timing data using a timing device;
inhibiting the recording of timing data to a recording medium during a period from changing the timing data to predetermined initial data to changing the timing data into indicated other data; and
recording the indicated other data onto the recording medium.
